(19) United States
(12) Patent Application Publication
(10) Pub. No.: US 2011/0094229 A1
(43) Pub. Date: Apr. 28, 2011

(54) ADIABATIC COMPRESSED AIR ENERGY STORAGE SYSTEM WITH COMBUSTOR

(76) Inventors: Sebastian W. Freund, Unterföhring (DE); Mathias Finkenrath, Garching b. Muenchen (DE)

(21) Appl. No.: 12/606,431

(22) Filed: Oct. 27, 2009

(51) Int. Cl. F02C 6/16; F02C 6/14; F02C 7/08; F02C 7/10; F02C 9/00

(52) U.S. Cl. 60/727; 60/773; 60/39.15

(57) ABSTRACT

A system includes a drive shaft, a motor-generator coupled to the drive shaft, a compressor coupled to the drive shaft and configured to output compressed air to a cavern, and a turbine coupled to the drive shaft and configured to receive air from the cavern. The system includes a first thermal energy storage (TES) device, a combustor configured to combust a flammable substance and generate an exhaust stream to the turbine, and controller. The controller is configured to control flow of the air to heat the air as it passes through the first TES, cause the flammable substance to flow to the combustor, operate the combustor to combust the air with the flammable substance to generate an exhaust stream into the turbine, and control the motor-generator to generate electrical energy from energy imparted thereto from the turbine via the drive shaft.

### BACKGROUND OF THE INVENTION

Embodiments of the invention generally relate to compressed air energy storage systems and, more particularly, to a system and method of maximizing power output and efficiency in an adiabatic air energy storage system.

Compressed air energy storage systems include diabatic compressed air energy storage (diabatic-CAES) and adiabatic compressed air energy storage (ACAES). Such systems typically store compressed air to 80 bars or more, where the energy stored is available to later power a turbine to generate electricity. Typically, the compressed air can be stored in several types of underground media that include but are not limited to porous rock formations, depleted natural gas/oil fields, and caverns in salt or rock formations. In one example, a man-made solution-mined salt cavern of approximately 19.6 million cubic feet operates between 680 psi and 1280 psi, and is capable of providing power for a continuous time duration of 26 hours. Alternatively, the compressed air can be stored in above-ground systems such as, for example, high pressure pipelines similar to that used for conveying natural gas. However, above-ground systems tend to be expensive and typically do not have a storage capacity comparable to an underground cavern—though they can be attractive in that they can be sited in areas where underground formations are not available.

Often, the use of a diabatic-CAES or an ACAES system is reserved to provide electrical power to a grid during peak-power needs, thus offsetting power generation costs during more expensive peak/daytime hours. Further, diabatic-CAES or ACAES systems may provide additional power capacity that may obviate the need to build additional conventional power generation capacity such as in gas or coal-fired power plants.

Diabatic-CAES/ACAES systems typically include a compression train having one or more compressors that compress intake air and provide the compressed air to a cavern or other compressed air storage component during an energy storage stage. The energy storage stage operation may derive power from an electric grid during, for instance, relatively less-expensive, off-peak, or low-demand hours such as at night. Alternatively, energy storage operation may derive power from renewable sources such as wind, sun, rain, tides, and geothermal heat, as examples, which often provide intermittent power that may be during less desirable low-demand evening hours. The compressed air is then later available to drive one or more turbines to produce energy such as electrical energy during an energy generation stage as described. The energy generation stage of a diabatic-CAES or ACAES system typically occurs during high-energy needs and peak demand times and its operation may be dictated by efficiency or other considerations such as, as stated, displacing the cost of construction of additional power capacity.

During operation of the compression stage of a diabatic-CAES system, the compressed air typically exits the compressor having an elevated temperature of, for instance, between 550° C. and 650° C., which is due in large part to heat of compression of the air. Thus, the process of compressing the air results in a heat of compression, and the amount of energy contained therein is a function of at least its temperature difference with ambient, its pressure (i.e., a total mass of gas), and its heat capacity. However, although the heat of compression may be present when entering the cavern, its energetic value is largely diminished as it mixes with cavern air, and as it further cools to surrounding or ambient temperature during storage. Thus, diabatic-CAES systems do not store the heat of compression, and the availability due thereto is lost—leading to a low overall efficiency.

ACAES systems, on the other hand, improve system efficiency by capturing and storing the heat of compression for later use. In such a system a thermal energy storage (TES) system or unit is positioned between the compressor and the cavern. Typically, a TES includes a medium for heat storage, and hot air from the compression stage is passed therethrough, transferring its heat of compression to the medium in the process. Some systems include air that exits the TES at or near ambient temperature, thus the TES is able to store a larger fraction of energy that is due to compression, as compared to a diabatic system. As such, the air enters the cavern at or near ambient temperature, and little energy is lost due to any temperature difference between the compressed air and ambient temperature.

Overall, both such systems (diabatic CAES and ACAES) may have their efficiency improved by including multiple stages of operation. Thus, some known systems include, as an example, low, medium, and high stages where a gas is compressed in first, second, and third stages before going to a cavern for storage. Energy may be drawn therefrom, similarly, through the multiple stages including respectively, third, second, and first stages while generating electrical power through a generator. And, as in the adiabatic systems described above, such a multi-stage system may store energy from the heat of compression via a TES after one or multiple stages of compression, and draw energy therefrom during a power generation stage.

However, despite a multi-stage operation, an adiabatic operation of an ACAES, and a corresponding efficiency improvement thereof over a diabatic system, ACAES systems nevertheless lose energy due to other thermodynamic limitations, such as friction in the turbines and other second-law effects. Thus, because of the inherent thermodynamic limitations, ACAES systems take more energy from an electrical grid than they provide back to the grid during power generation from storage. Accordingly, their operation is dictated by economic considerations as well. As such and despite charging during low-cost/low-demand periods and drawing during high-profit peak capacity periods, their operation is limited, and profitability may be compromised due to the lost power.

Further, one reason for implementing an air storage system is to provide additional peak power capability to augment electrical power production provided by other power generating systems, such as coal-fired or natural gas-fired systems. However, in instances where the air storage cavern or the TES is depleted, it is possible that peak power demands from the electrical grid may not be met by using the air storage system. In other words, an air storage system typically provides additional power generation capability from a turbine/generator combination, but power may not be available therefrom during the times when it is needed most—during peak power demand.

Thus, there is a need for a system and method of producing additional power during periods of peak demand in a compressed air storage system. There is also a need for a system and method of producing additional energy in a compressed air storage system to maximize total energy production therefrom when such energy can command a profitable return by providing electrical power to an electrical grid.

Therefore, it would be desirable to design an apparatus and method that overcomes the aforementioned drawbacks.

### BRIEF DESCRIPTION OF THE INVENTION

Embodiments of the invention provide an apparatus and method for storing and retrieving energy via an air cavern.

In accordance with one aspect of the invention, an air compression and expansion system includes a drive shaft, a motor-generator coupled to the drive shaft, a compressor coupled to the drive shaft and configured to output compressed air to a cavern via a first line, and a turbine coupled to the drive shaft and configured to receive air from the cavern via a second line. The system includes a first thermal energy storage (TES) device having the first line and the second line thermally coupled thereto, a combustor thermally coupled to the second line, the combustor configured to combust a flammable substance and generate an exhaust stream to the turbine via the second line, and a controller. The controller is configured to control flow of the air through the second line to heat the air as it passes through the first TES, cause the flammable substance to flow to the combustor, operate the combustor to combust the air from the second line and the flammable substance to generate an exhaust stream into the turbine, and control the motor-generator to generate electrical energy from energy imparted thereto from the turbine via the drive shaft.

In accordance with another aspect of the invention a method of operating a system for compressing and expanding gas includes compressing a working fluid with a compressor, transferring heat from the working fluid to a thermal energy storage (TES) unit, storing the compressed working fluid in an enclosure, passing the compressed working fluid from the enclosure to the TES, transferring heat from the TES to the compressed working fluid passing therethrough, passing the compressed working fluid through a combustor and combusting a flammable fluid therewith to generate a stream of exhaust products, and propelling a turbine with the stream of exhaust products.

In accordance with yet another aspect of the invention a controller is configured to cause air to be supplied to a compressor, cause the compressor to pressurize and heat the air, direct the air that has been pressurized and heated to pass through a heat storage device configured to cool the air, cause the air that has been cooled and pressurized to be stored in an enclosure, cause the air stored in the enclosure to be drawn out of the enclosure and through the heat storage device, cause a combustor to ignite to generate an exhaust stream by igniting a flammable fluid with the air drawn through the heat storage device, and direct the exhaust stream to a turbine to generate electrical power.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a flowchart of a technique for operating a compressed air storage system, according to embodiments of the invention.

FIG. 2 is an illustration of a compressed air storage system, according to an embodiment of the invention.

FIG. 3 an illustration of a compressed air storage system, according to an embodiment of the invention.

### DETAILED DESCRIPTION

According to embodiments of the invention, a system and method are provided that optionally augment an energy content of air passing from a pressurized air cavern to a turbine to generate electrical power therefrom.

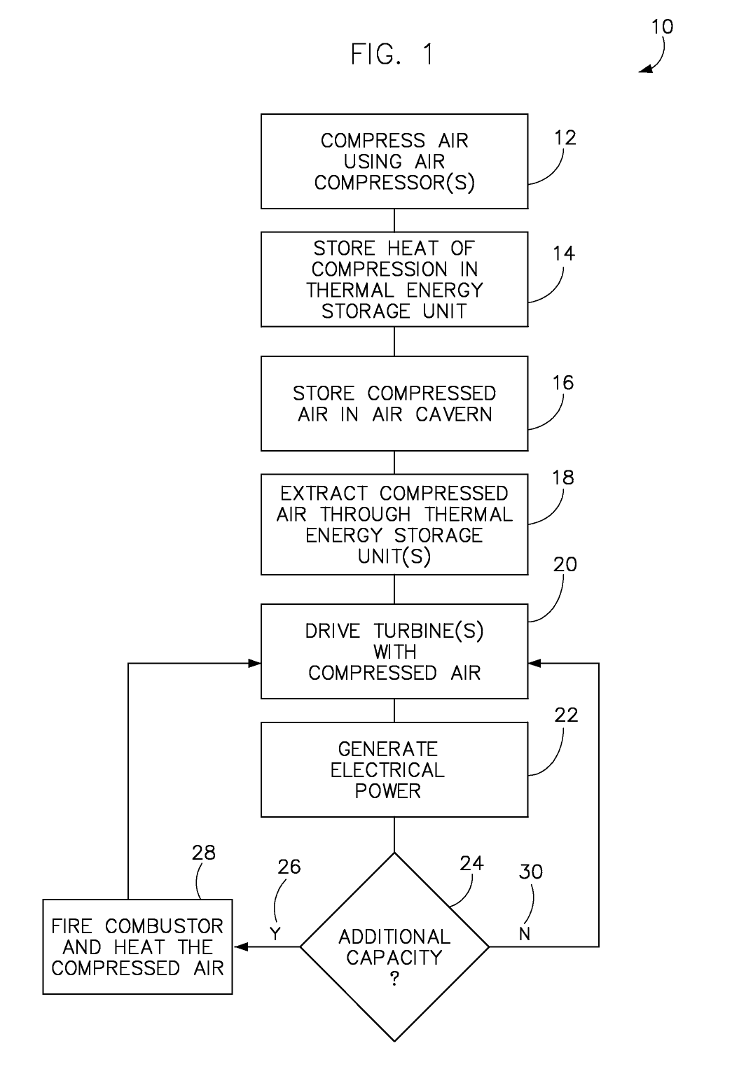

Referring to FIG. 1, a technique 10 for operating a compressed air storage system includes compressing a working fluid such as air using one or more air compressors 12, storing the heat of compression in one or more thermal energy storage units (TES) 14, and storing the compressed air in an air cavern 16, according to embodiments of the invention. Energy is thus stored in one or more TES units as thermal energy that is available for later extraction via heat exchange with air passing therethrough. Air is extracted therefrom 18 through the one or more TES units, and one or more turbines is driven 20 with the compressed air. The turbine(s), in turn, generate electrical power 22 via, for instance, an electrical generator.

Technique 10 includes determining 24 whether the turbine(s) or the generator have additional output capacity that is not being fully utilized. If either or both have additional capacity 26, then a combustor is fired 28, according to an embodiment of the invention, to heat air passing from the TES(s) to the turbine. That is, the combustor is fired at step 28 so long as such operation is within limits of system operation and does not exceed other capacity or temperature limitations. If there is no additional capacity 30 in the turbine(s) or the generator, then the turbine(s) continues to drive using compressed air without further augmentation from the combustor. Further, according to embodiments of the invention, step 28 includes controlling a fuel flow rate to the combustor to maximize power output without exceeding capacity or temperature limitations of system components. Thus, at step 24 when technique 10 includes determining whether, for instance, the turbine(s) or generator have additional capacity, such determination then enables step 28 to also determine, control, and alter fuel flow rate through the combustor, according to embodiments of the invention.

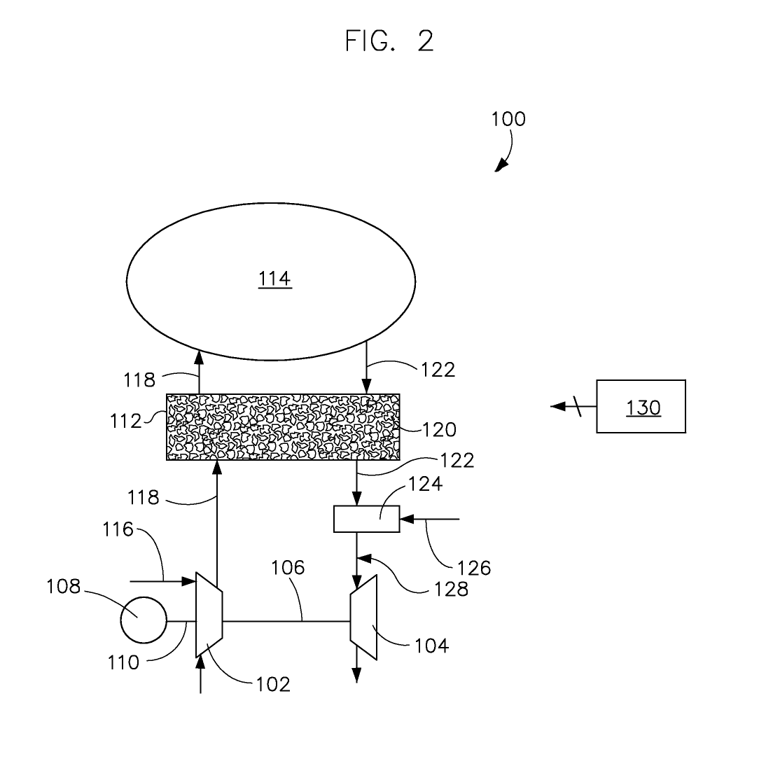

Technique 10 is described with respect to system 100 illustrated in FIG. 2. Referring to FIG. 2, system 100 includes a compressor 102 coupled to a turbine 104 via a shaft 106. Compressor 102 is also mechanically coupled to a generator/motor 108 via a shaft 110 that is configured to generate electrical power when shaft 110 is rotated. System 100 includes a thermal energy storage (TES) system 112 and an air storage cavern 114. An input line 116 is configured to input air to compressor 102, and an output or conveyance line 118 is configured to output compressed air from compressor 102 to TES 112, and from TES 112 to air storage cavern 114. In embodiments of the invention, TES 112 includes a medium 120 that is configured to store the large amounts of energy from the heat of compression, and the medium typically includes a high heat capacity material. For instance, medium 120 may include concrete, stone, a fluid such as oil, a molten salt, or a phase-change material.

System 100 also includes an output or conveyance line 122 to output compressed air from air storage cavern 114, through TES 112, to a combustor 124. Combustor 124 includes a fuel inlet line 126 for conveying a flammable fluid such as natural gas, methane, propane, and a biofuel, such that the flammable fluid passing to combustor 124 may be combusted therein with air from air storage cavern 114 and passing through TES 112. Exhaust products at high temperature and pressure from combustor 124 are passed to turbine 104 via an exhaust line 128. In conditions of operation of system 100 when no combustion is caused to occur in combustor 124, then air passing from air cavern 114 and through TES 112 is simply passed through combustor 124 to turbine 104 to generate electrical energy therefrom in generator/motor 108.

System 100 may be operated in a manner as described in FIG. 1 as discussed, according to an embodiment of the invention. Thus, system 100 includes a controller 130 that may cause system 100 to operate in a charging mode by charging air storage cavern 114 via compressor 102 using energy from an electrical grid to power generator/motor 108, or using energy from a renewable source such as wind power. The air is compressed and heated in compressor 102 and passed through TES 112. The heat of compression is removed, and the compressed air passing through output line 118 is cooled therein. The air is passed to air storage cavern 114 and available to be drawn later therefrom.

During a discharge mode, controller 130 causes air to be discharged from air storage cavern 114 at elevated pressure with respect to an ambient pressure and passed to turbine 104 to cause rotation thereof. As the air passes through output or conveyance line 122 and through TES 112, the air is heated. Thus, the heat of compression is recovered by using the TES, previously heated by the heat of compression, to heat the air as it passes from air storage cavern 114. However, in some conditions, the TES 112 may become partially or fully depleted of thermal energy. In other conditions, the TES may not heat the air to a level that can take full advantage of an output capacity of turbine 104 or of generator/motor 108. Thus, in some conditions of operation such as, for instance, during periods of extended system usage when the TES may have diminished energy storage therein or may be depleted, air passing from air storage cavern 114 to turbine 104 may not have enough energy content to cause turbine 104 to operate at its maximum capacity. As such, combustor 124 may be optionally fired, according to embodiments of the invention, to add thermal energy to air passing from air cavern 114 and through TES 112.

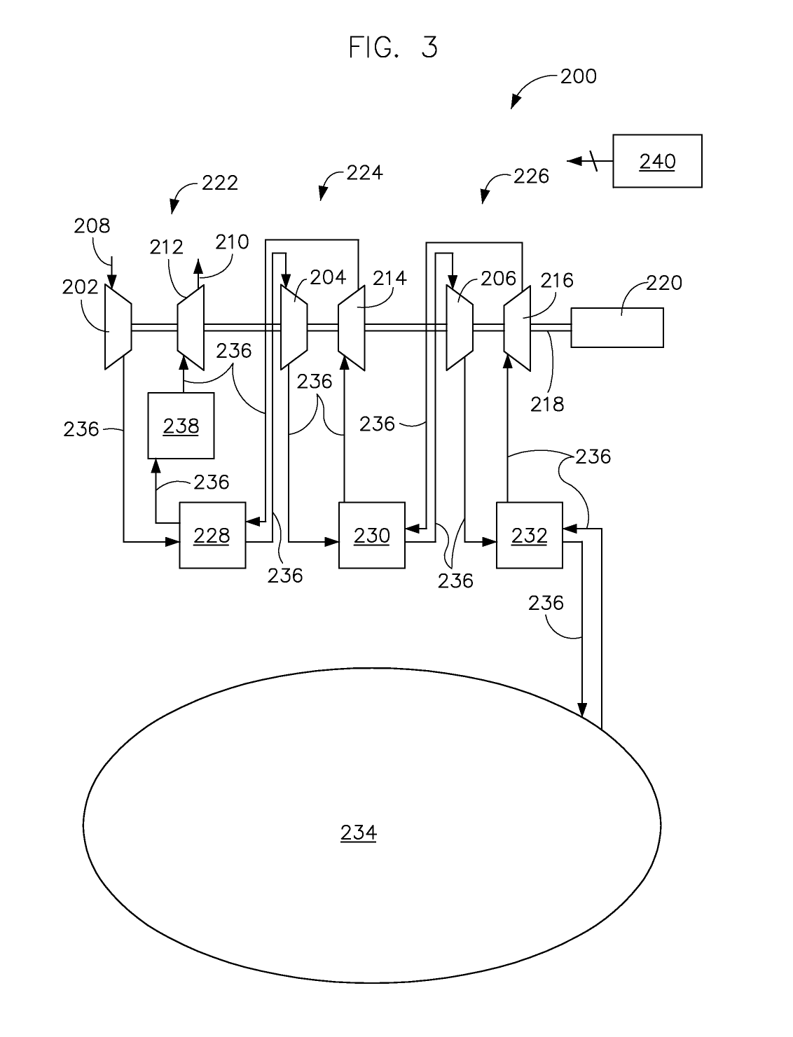

Referring now to FIG. 3, a multi-stage system 200 includes multiple compressors and turbines, according to an embodiment of the invention. Each stage of multi-stage system 200 is configured to step up pressure during a storage or charging phase, and step down pressure during a release or discharging phase, through respective pressure differences, such that overall system efficiency is approved when considered against a single-stage compressor/turbine combination, as understood in the art.

System 200 includes a first compressor 202, a second compressor 204, and a third compressor 206. First compressor 202 includes an air inlet line 208 and an air outlet line 210. System 200 also includes a first turbine 212, a second turbine 214, and a third turbine 216. Compressors 202-206 and turbines 212-216 are coupled together via a shaft 218, which is coupled to a motor/generator 220. Each stage of compression in compressors 202-206 and expansion in turbines 212-216 includes a respective step-up and step-down of pressure through low 222, medium 224, and high 226 stages or pressure levels. Each stage 222-226 includes a respective regenerative thermal energy storage (TES) unit 228, 230, and 232 . The stages 222-226 and respective TES units 228-232 are coupled to an air cavern 234 via a plurality of conveyance lines 236 as illustrated.

System 200 includes a combustor 238 coupled to first turbine 212. Components of system 200 may be controlled via a controller 240 to increase power capacity and output of motor/generator 220 according to embodiments of the invention. Thus, controller 240 may cause system 200 to operate in both a charging and a discharging mode. In a charging mode, controller 240 causes motor/generator 220 to draw energy from an electrical grid or other source and to rotate shaft 218 to cause compressors 202-206 and turbines 212-216 to rotate. Air is drawn into 202 via air inlet 208, compressed to a first pressure in first compressor 202, and discharged through TES 228 to second compressor 204. As the air at the first pressure passes through TES 228 it transfers its heat of compression thereto to be stored therein. The air is compressed from the first pressure to a second pressure in second compressor 204 and is passed through TES 230 to third compressor 206. As the air at the second pressure passes through TES 230 it transfers its heat of compression thereto to be stored therein. The air is compressed from the second pressure to a third pressure in third compressor 206 and is discharged through TES 232 to air cavern 234. As the air passes through TES 232 it transfers its heat of compression thereto to be stored therein. Accordingly, system 200 is configured to pressurize air, in this embodiment, through three stages of compression, store the pressurized air in air cavern 234, and store the heat of compression in TES units 228, 230, and 232.

In a discharging mode, when electrical energy is desired to be generated and provided to an electrical grid, controller 240 causes compressed air to be drawn from air cavern 234, passed through TES 232, and conveyed to third turbine 216. The air is thus pre-heated before passing to third turbine 216. The air is expanded in third turbine 216, heated as it passes through TES 230, and passed to second turbine 214. The air is then passed through TES 228 to first turbine 212. As the air passes through turbines 216, 214, and 212, it imparts its energy to shaft 218 and causes shaft 218 to spin, which in turn imparts its energy to motor/generator 220 to generate electrical energy. Accordingly, energy contained in air cavern 234 in the form of high pressure, and energy contained in TES units 232, 230, and 228 in the form of thermal energy, is imparted to the air and both such sources (pressure in cavern 234 and thermal energy in TES units 232-228) contribute to energy content of the air stream passing through turbines 216, 214, and 212 and causing electrical generation thereof in motor/generator 220.

However, as one or more of the TES units 228-232 become depleted of thermal energy, and as air cavern 234 becomes depleted of energy as its pressure decreases, energy content of the air passing through conveyance lines 236 and through turbines 212-216 may be augmented, according to embodiments of the invention. Thus, controller 240 may cause system 200 to operate as described in technique 10 of FIG. 1 above. As air passes through lines 236 to power motor/generator 220 via shaft 218, energy may be added to the air by firing combustor 238 when a capacity of turbines 212-216 or when a capacity of motor/generator 220 is not at a maximum. Accordingly, output of system 200 may be maximized, as discussed, according to an embodiment of the invention.

One skilled in the art will recognize that, although three stages 222-226 are illustrated (with each stage including a respective compressor and turbine), multi-stage system 200 may include less or more than three stages, according to embodiments of the invention. Further, it is to be recognized that equal numbers of compressors and turbines need not be included, according to the invention. For instance, system 200 may include two compressors and four turbines, as an example. Further, although system 200 illustrates combustor 238 positioned between TES 228 and turbine 212, it is to be recognized that combustor 238 may be positioned elsewhere in system 200, according to embodiments of the invention. For instance, line 236 that passes air from TES 236 to turbine 214 may include combustor 238. Further, according to the invention, system 200 may include multiple combustors between a TES and a turbine to which air passes therefrom, though only one is illustrated.

A technical contribution for the disclosed method and apparatus is that is provides for a computer implemented system and method of maximizing power output and efficiency in an adiabatic air energy storage system.

Therefore, according to one embodiment of the invention an air compression and expansion system includes a drive shaft, a motor-generator coupled to the drive shaft, a compressor coupled to the drive shaft and configured to output compressed air to a cavern via a first line, and a turbine coupled to the drive shaft and configured to receive air from the cavern via a second line. The system includes a first thermal energy storage (TES) device having the first line and the second line thermally coupled thereto, a combustor thermally coupled to the second line, the combustor configured to combust a flammable substance and generate an exhaust stream to the turbine via the second line, and a controller. The controller is configured to control flow of the air through the second line to heat the air as it passes through the first TES, cause the flammable substance to flow to the combustor, operate the combustor to combust the air from the second line and the flammable substance to generate an exhaust stream into the turbine, and control the motor-generator to generate electrical energy from energy imparted thereto from the turbine via the drive shaft.

According to another embodiment of the invention a method of operating a system for compressing and expanding gas includes compressing a working fluid with a compressor, transferring heat from the working fluid to a thermal energy storage (TES) unit, storing the compressed working fluid in an enclosure, passing the compressed working fluid from the enclosure to the TES, transferring heat from the TES to the compressed working fluid passing therethrough, passing the compressed working fluid through a combustor and combusting a flammable fluid therewith to generate a stream of exhaust products, and propelling a turbine with the stream of exhaust products.

According to yet another embodiment of the invention a controller is configured to cause air to be supplied to a compressor, cause the compressor to pressurize and heat the air, direct the air that has been pressurized and heated to pass through a heat storage device configured to cool the air, cause the air that has been cooled and pressurized to be stored in an enclosure, cause the air stored in the enclosure to be drawn out of the enclosure and through the heat storage device, cause a combustor to ignite to generate an exhaust stream by igniting a flammable fluid with the air drawn through the heat storage device, and direct the exhaust stream to a turbine to generate electrical power.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An air compression and expansion system comprising:
a drive shaft;
a motor-generator coupled to the drive shaft;
a compressor coupled to the drive shaft and configured to output compressed air to a cavern via a first line;
a turbine coupled to the drive shaft and configured to receive air from the cavern via a second line;
a first thermal energy storage (TES) device having the first line and the second line thermally coupled thereto;
a combustor thermally coupled to the second line, the combustor configured to combust a flammable substance and generate an exhaust stream to the turbine via the second line; and
a controller configured to:
control flow of the air through the second line to heat the air as it passes through the first TES;
cause the flammable substance to flow to the combustor;
operate the combustor to combust the air from the second line and the flammable substance to generate an exhaust stream into the turbine; and
control the motor-generator to generate electrical energy from energy imparted thereto from the turbine via the drive shaft.

2. The air compression and expansion system of claim 1 wherein the controller is further configured to determine whether one of the motor-generator and the turbine has additional capacity and, if so, then the controller is configured to increase a flow rate of the flammable substance to the combustor.

3. The air compression and expansion system of claim 1 wherein the controller is further configured to:
draw power from an electrical grid via the motor-generator;
power the compressor using the drawn power via the drive shaft to cause the compressor to compress the air; and
pass the compressed air from the powered compressor to the cavern via the first line.

4. The air compression and expansion system of claim 1 wherein:
the first line is a fluidic pathway passing at least from an outlet of the compressor, through the first TES, and to an inlet to the cavern; and
the second line is a fluidic pathway passing at least from an outlet of the cavern, through the first TES, through the first combustor, and to an inlet of the turbine.

5. The air compression and expansion system of claim 1 wherein the flammable substance comprises one of natural gas, methane, propane, and a biofuel.

6. The air compression and expansion system of claim 1 wherein the system comprises multiple compressor and turbine combinations fluidically coupled to the cavern.

7. The air compression and expansion system of claim 6 wherein the multiple compressor and turbine combinations are coupled to one another via the drive shaft that is a common drive shaft.

8. The air compression and expansion system of claim 6 wherein the multiple compressor and turbine combinations are fluidly serially coupled one to another and wherein each multiple compressor and turbine combination comprises a respective one of a low pressure stage, a medium pressure stage, and a high pressure stage.

9. The air compression and expansion system of claim 8 wherein a pressure ratio in the low pressure stage is greater than a pressure ratio in either of the medium and high pressure stages.

10. The air compression and expansion system of claim 8 further comprising:
a second TES device coupled between the low pressure stage and the medium pressure stage; and
a third TES device coupled between the medium pressure stage and the high pressure stage.

11. A method of operating a system for compressing and expanding gas, the method comprising:
compressing a working fluid with a compressor;
transferring heat from the working fluid to a thermal energy storage (TES) unit;
storing the compressed working fluid in an enclosure;
passing the compressed working fluid from the enclosure to the TES;
transferring heat from the TES to the compressed working fluid passing therethrough;
passing the compressed working fluid through a combustor and combusting a flammable fluid therewith to generate a stream of exhaust products; and
propelling a turbine with the stream of exhaust products.

12. The method of claim 11 further comprising providing a common shaft, and mechanically coupling the compressor and the turbine to the common shaft.

13. The method of claim 11 further comprising drawing power from an electrical grid, wherein the step of compressing the working fluid includes supplying the electrical power drawn from the electrical grid to the compressor to compress the working fluid.

14. The method of claim 11 wherein the flammable fluid includes one of natural gas, methane, propane, and a biofuel.

15. The method of claim 11 wherein the step of compressing comprises compressing the working fluid through multiple compressors and wherein the step of expanding comprises expanding the working fluid through multiple turbines.

16. A controller configured to:
cause air to be supplied to a compressor;
cause the compressor to pressurize and heat the air;
direct the air that has been pressurized and heated to pass through a heat storage device configured to cool the air;
cause the air that has been cooled and pressurized to be stored in an enclosure;
cause the air stored in the enclosure to be drawn out of the enclosure and through the heat storage device;
cause a combustor to ignite to generate an exhaust stream by igniting a flammable fluid with the air drawn through the heat storage device; and
direct the exhaust stream to a turbine to generate electrical power.

17. The controller of claim 16 wherein the controller, in being configured to cause the compressor to pressurize and heat the air, is configured to cause a compressor supply power to be drawn from one of an electrical grid and a wind turbine and supplied to the compressor.

18. The controller of claim 16 wherein the flammable fluid is one of natural gas, methane, propane, and a biofuel.

19. The controller of claim 16 wherein the controller is configured to cause multiple compressors to pressurize and heat the air through multiple pressure stages, and wherein the controller is configured to cause air to pass through at least one turbine prior to selectively causing the combustor to ignite and generate the exhaust stream.

20. The controller of claim 16 wherein the controller is configured to determine whether to ignite the combustor based on one of a pressure in the enclosure and a temperature of air exiting the heat storage device.

21. The controller of claim 16 wherein the heat storage device includes one of concrete, stone, an oil, a molten salt, and a phase-change material.
